(19) United States
(12) Patent Application Publication
(10) Pub. No.: US 2007/0076523 A1
(43) Pub. Date: Apr. 5, 2007

(54) BLENDER BLADES FOR REDUCING PLATE OUT

(76) Inventor: Dirk Yerian, Akron, OH (US)

Correspondence Address: Kathleen K. Bowen, 311 Hillbrook Dr, Cuyahoga Falls, OH, 44223, US

(21) Appl. No.: 11/532,535

(22) Filed: Sep. 17, 2006

Related U.S. Application Data
(60) Provisional application No. 60/717,805, filed on Sep. 17, 2005.

(51) Int. Cl. B01F 7/20

(52) U.S. Cl. 366/314; 366/325.2

(57) ABSTRACT

A high intensity blender for mixing color pigment into plastics wherein the mixing is done by blender blades, which have a length, and a cross section perpendicular to that length, wherein the blender blades are mounted on a hub, wherein the hub is driven by a mixer motor, the improvement comprises, wherein no dimension of the cross-section is greater than 5/8 inch. A preferred embodiment has the cross section being round for the majority of the blade length, and the tip of the blade adapted to have a rectangular cross section.

This application claims the benefit of U.S. Provisional Application No. 60/717,805, filed Sep. 17, 2005.

### BACKGROUND

The present invention is in the field of blenders and mixers. More specifically this invention relates to high intensity blenders for mixing color pigment into materials in the plastics industry.

Standard blades for high intensity blenders are like oversized home blender blades. When mixing color pigment in using these types of blades, the pigment will often build up on the blade surface. When it builds thick enough, it will shear or flake off leaving heavily concentrated flakes of color pigment. Not only can this effect the aesthetics of the product, but it can also weaken the part due to lack of resin in that location.

A blender and blender blades are desired which would reduce the size and number of these pigment flakes, and which would be adaptable for many different applications.

### SUMMARY

A high intensity blender for mixing color pigment into plastics wherein the mixing is done by blender blades, which have a length, and a cross section perpendicular to that length, wherein the blender blades are mounted on a hub, wherein the hub is driven by a mixer motor, the improvement comprises, wherein no dimension of the cross-section is greater than ⅝ inch. A preferred embodiment has the cross section being round for the majority of the blade length, and the tip of the blade adapted to have a rectangular cross section.

### BRIEF DESCRIPTION OF THE DRAWINGS

FIG. 1 is a cross-section view of a mixer according to an aspect of the invention.

FIG. 2 is an isometric view of a blender-blade/hub apparatus, according to an aspect of the invention.

FIG. 3 is an isometric view of a blender blade according to an aspect of the invention.

FIG. 4 is a side view of a blender blade according to an aspect of the invention.

FIG. 5 is a top view of a blender blade according to an aspect of the invention.

FIG. 6 is an isometric view of a blender blade according to an aspect of the invention.

FIG. 26 is a cross section view from FIG. 3.

FIG. 7 is a top view of a blender blade according to an aspect of the invention.

FIG. 27 is a cross section view from FIG. 7.

FIG. 8 is an end view of a blender blade according to an aspect of the invention.

FIG. 9 is a side view of a blender blade according to an aspect of the invention.

FIG. 10 is a top view of a blender blade according to an aspect of the invention.

FIG. 11 is a cross section view from FIG. 10.

FIG. 12 is an isometric view of a blender-blade/hub apparatus, according to an aspect of the invention.

FIG. 13 is a top view of a key according to an aspect of the invention.

FIG. 14 is an isometric view of a key according to an aspect of the invention.

FIG. 15 is an isometric view of a hub according to an aspect of the invention.

### DETAILED DESCRIPTION

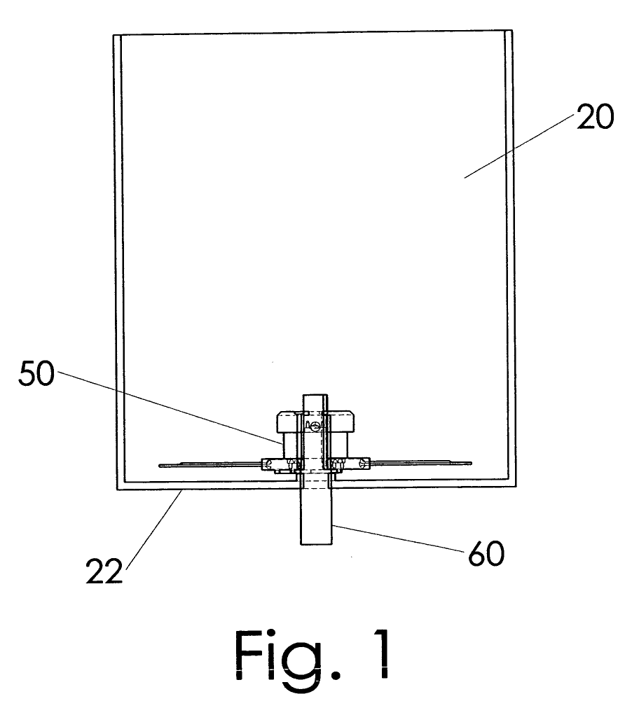

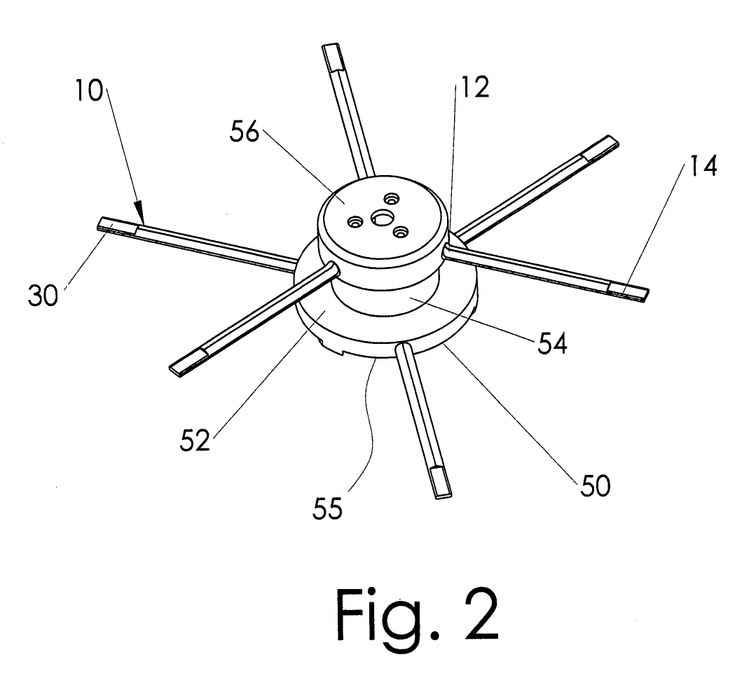

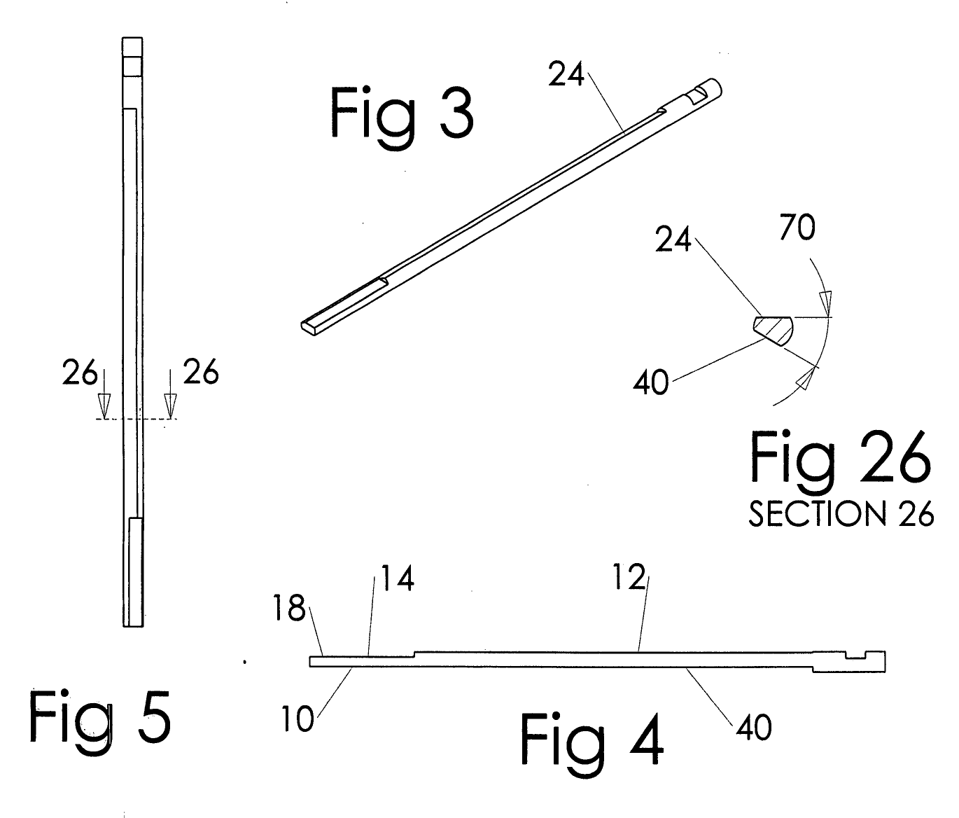

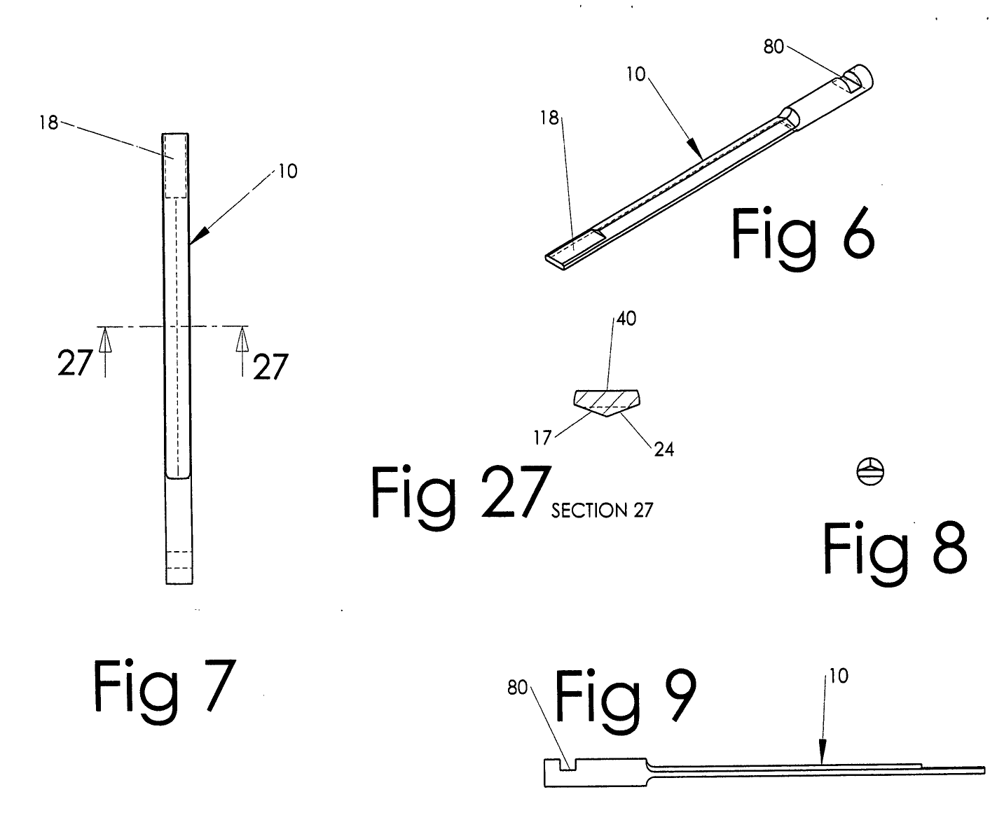

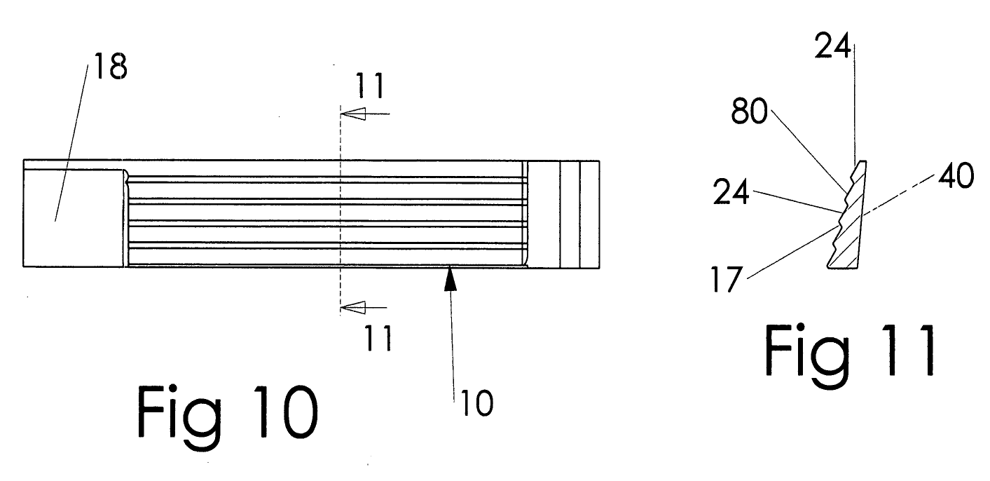

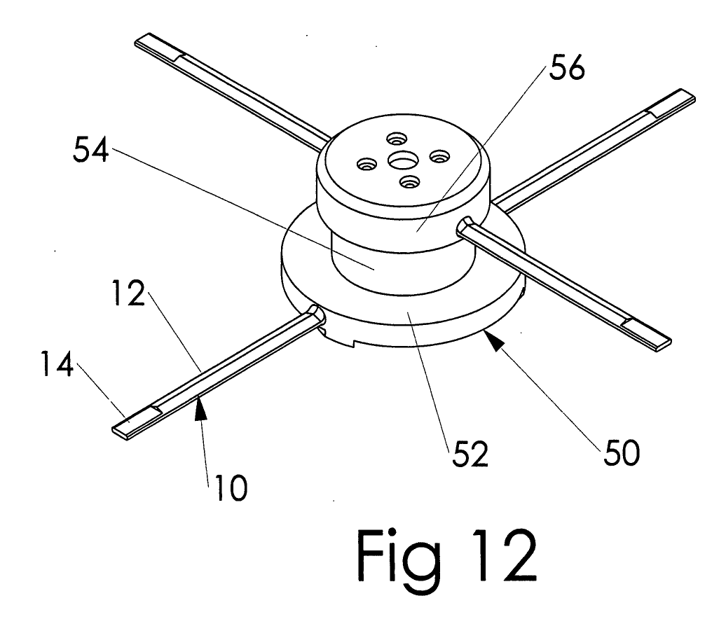

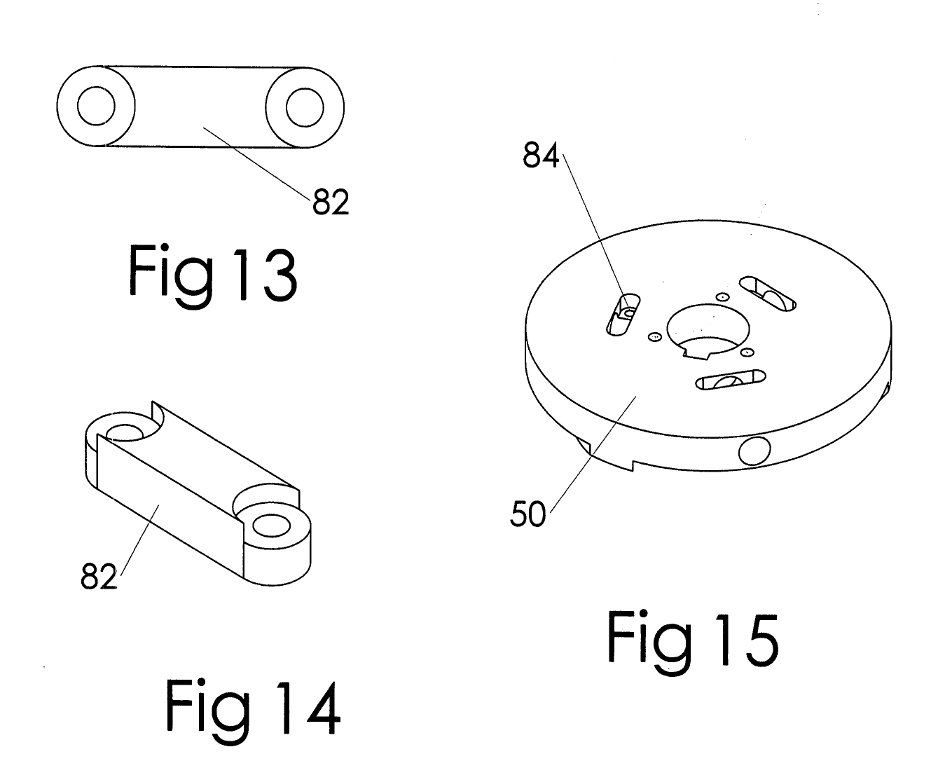

Various aspects of the invention are presented in FIGS. 1-27 which are not drawn to scale and in which like components are numbered alike. To reduce the amount of plate-out, or flaking-off of pigment, the present invention reduces the surface area of the blades significantly. Referring now to FIG. 1, according to an aspect of the invention, blender blades 10 for use in a mixer 20 comprise round pins 30. According to an aspect of the invention, the round pins 30 are comprised of ½ inch diameter round stock. In a preferred embodiment of the invention, the round pins 30 are comprised of ⅝ inch diameter round stock. The use of a round pin for a blade is very effective for liquid color. Some applications may be better suited by a smaller diameter pin, such as a ⅜″.

For dry pigment, or powder, the blades work better with some form of leading edge. For these applications, according to an aspect of the invention, the blades 10 are adapted to have a flat side 40 which faces the mixer bottom 22 when the blade 10 is installed in the mixer 20. The blades 10 are further adapted to have an leading edge angled side 24 on a side opposing the flat side 40 such that the blade 10 as such adapted has a wedge shaped cross section 26. There is no need to start with a round pin to end with this cross-section, as this could be machined out of any suitable material, including flat stock. The wedge shaped cross-section 26 moves through the material being blended such that the smallest part of the wedge is the leading edge of the blade 10. This reduces friction, and in turn reduces heat. This helps reduce pigment build-up, and reduces the motor requirements.

According to a preferred embodiment of the invention, the blender blades 10 are driven by a hub 50 which is in turn driven by a mixer motor 60, wherein the blender blades 10 have an inner end 12 attachable to the hub 50, and an outer end 14 opposing the inner end 12, wherein the outer end 14 is adapted to have a flat side 40 which faces the mixer bottom 22 when the blade 10 is installed in the mixer 20, and an opposing flat side 18 which faces away from the mixer bottom 22 when the blade 10 is installed in the mixer 20.

Thus, at the blade outer end 14 where the blade is moving at higher speeds (feet per second), there is no angle for the pigment to build up on. The distance along the blade which is cut flat on both sides can be determined after use, so that it can be observed where the material builds up due to blade tip speed.

According to a preferred embodiment of the invention, the blade 10 has a flat side 40 over its length, facing the mixer bottom when installed, and an angle over the inner blade 12 top side (side facing away from the mixer bottom), and a flat on the outer blade 14 top side.

According to an aspect of the invention, the inner blade top side 12 has two angles, a leading edge angle 24, which angles away from the mixer bottom 22, and a trailing edge angle 17 which angles back towards the mixer bottom 22. A blade shaped as such may be machined from round stock or flat stock, or any other suitable material. To reduce the opportunity for pigment build-up on the blades, the leading edge angle 24 should be relatively small, in a preferred embodiment about ⅝ of an inch. If a larger blade is desired, the blade can have multiple leading edge angled 24 sections, forming a saw tooth shaped profile 80. In this embodiment, the trailing edge angles 17 may be almost perpendicular to the mixer bottom 22.

According to an aspect of the invention, the angled side 24 makes an angle 70 of approximately 30 degrees, relative to the flat side 40. This is just one possible angle as the size of the blade and its intended use factors, such as the speed at which it will be run, will affect the choice of an optimum angle.

According to a further aspect of the invention, a high intensity blender 20 for mixing color pigment into plastics, wherein the mixing is done by blender blades 10, wherein the blender blades 10 are mounted on a hub 50, wherein the hub 50 is driven by a mixer motor 60, the improvement comprising the blender blades 10 having a length 15, and a cross-section 26 perpendicular to that length 15, wherein no dimension of the cross-section 26 is greater than ½ inch.

In a preferred embodiment of the invention, no dimension of the cross-section 26 is greater than ⅜ inch.

According to an aspect of the invention, the blender blades 10 are individually removable and replaceable. This is on contrast to much of the prior art, where the blades are welded to the hub. This allows individual blades to be replaced when worn, as opposed to having to replace all of the blades. According to an aspect of the invention, the blades have a notch 80 on the end of the blade which is attached to the hub 50. Keys 82 slide into the groove 80, and are used for attachment to the hub 50. The hub 50 further has receptacles 84 for receiving the keys 82, thus attaching the blades to the hub 50.

In a further embodiment, the hub 50 comprises three separate pieces; a bottom blade disk 52, a middle spacer 54, and a top blade disk 56, wherein the bottom blade disk 52 and the top blade disk 56 are adapted for installation of blender blades 10, and wherein the middle spacer 54 is adapted to connect the top blade disk 56 to the bottom blade disk 52. The blade disks (52 and 56) can be designed to hold multiple blade quantities, such as 0, 2, 3, 4, etc. blades 10 in each disk. Thus the number of blades can be adjusted to the particular requirements. Because the blades are removable, the mixer can be easily adjusted for condition changes. For example, if an application is using three blades 10 in the top blade disk 56, and three blades 10 in the bottom blade disk 52 during normal operation, during high heat/humidity days this may be too much. Therefore, the blades 10 could be removed from the top blade disk 56 leaving the operator with three blades, and less opportunity for plate out.

To further aid in emptying out the mixers, according to an aspect of the invention, fins may be added to the hub bottom side 55.

What is claimed is:

1. Blender blades for use in a mixer comprising:
round pins.

2. The blender blades of claim 1 wherein said round pins are comprised of ½ inch diameter round stock.

3. The blender blades of claim 1 wherein said round pins are comprised of ⅜ inch diameter round stock.

4. Blender blades for use in a mixer, wherein said mixer has a bottom, wherein said blender blades are located proximate to said mixer bottom, comprising:
a flat side which faces said mixer bottom when said blade is installed in said mixer; and,
an angled side on a side opposing said flat side such that said blender blade as such adapted has a wedge shaped cross section.

5. The blender blades of claim 4, wherein said blender blades are driven by a hub which is in turn driven by a mixer motor, wherein said blades have an inner end attachable to said hub, and an outer end opposing said inner end, wherein said outer end is adapted to have a flat side which faces said mixer bottom when said blade is installed in said mixer, and an opposing flat side which faces away from said mixer bottom.

6. The blender blades of claim 4 wherein said blender blades are driven by a hub which is in turn driven by a mixer motor, wherein said blades have an inner end attachable to said hub, and an outer end opposing said inner end, wherein said blender blades are located proximate to said mixer bottom, wherein said blades are adapted to have a flat edge which faces said mixer bottom when said blade is installed in said mixer, and an angle on a side opposing said flat side such that said blade as such adapted has a wedge shaped cross section, and further wherein said outer end is adapted to a rectangular shaped cross-section.

7. The blender blades of claim 4 wherein said angle is approximately 30 degrees, relative to said flat side.

8. A high intensity blender for mixing color pigment into plastics wherein said mixing is done by blender blades, wherein said blender blades are mounted on a hub, wherein the hub is driven by a mixer motor, the improvement comprising:
said blender blades have a length, and a cross-section perpendicular to that length, wherein no dimension of said cross-section is greater than ⅝ inch.

9. The high intensity blender of claim 8 wherein said blender blades are individually removable and replaceable.

10. The high intensity blender of claim 8 wherein said blades are round pins.

11. The high intensity blender of claim 8 wherein said blender has a bottom, wherein said blender blades are located proximate to said blender bottom, wherein said blades have a bottom side which faces said blender bottom, and a top side which faces away from said blender bottom, wherein said bottom side is flat, and wherein said top side is angled relative to said bottom side, such that said blade has a wedge shaped cross section, such that the smallest portion of the wedge is the leading edge.

12. The high intensity blender of claim 8 wherein said blades have an inner end attachable to said hub, and an outer end opposing said inner end, wherein said outer end is a rectangular shape.

13. The high intensity blender of claim 8 wherein said blender has a bottom, wherein said hub has a bottom side which faces said blender bottom, and a top side which faces away from said blender bottom, the improvement further comprising adding fins to said hub bottom side.

14. The high intensity blender of claim 8 the improvement further comprising said hub comprising three separate pieces; a bottom blade disk, a middle spacer, and a top blade disk, wherein said bottom blade disk and said top blade disk are adapted for installation of blender blades, and wherein said middle spacer is adapted to connect said top blade disk to said bottom blade disk.

15. The high intensity blender of claim 14 wherein said bottom blade disk and said top blade disk are adaptable to hold varying numbers of blades.
